(19) United States
(12) Patent Application Publication
(10) Pub. No.: US 2013/0227032 A1
(43) Pub. Date: Aug. 29, 2013

(54) METHOD FOR PROVIDING DIRECT PUSH E-MAIL SERVICE, AND E-MAIL CLIENT AND E-MAIL SERVER THEREFOR

(71) Applicant: SAMSUNG ELECTRONICS CO., LTD., (US)

(72) Inventor: Kyoung-Won KIM, Seoul (KR)

(73) Assignee: SAMSUNG ELECTRONICS CO., LTD., Gyeonggi-do (KR)

(21) Appl. No.: 13/684,819

(22) Filed: Nov. 26, 2012

(30) Foreign Application Priority Data
Feb. 24, 2012 (KR) 10-2012-0018958

(51) Int. Cl. H04L 12/58

(52) U.S. Cl. CPC H04L 51/00
USPC 709/206

(57) ABSTRACT

An E-mail client establishes a connection to an E-mail server to provide a Direct Push E-mail service by sending to the E-mail server a request message periodically to check whether an E-mail has arrived at the E-mail server and a connection item in a header of the request message, which is set as a closed state, and disconnects the connection upon receiving a response message to the command from the E-mail server. The E-mail server establishes a connection to the E-mail client to provide the Direct Push E-mail service by receiving the request message from the E-mail client, sending a response message to the command to the E-mail client, determining a connection item in a header of the request message, and disconnecting the connection if the connection item is set as a closed state.

### CLAIM OF PRIORITY

This application claims the benefit under 35 U.S.C. §119(a) of a Korean Patent Application filed in the Korean Intellectual Property Office on Feb. 24, 2012 and assigned Serial No. 10-2012-0018958, the entire disclosure of which is hereby incorporated by reference.

### BACKGROUND OF THE INVENTION

1. Field of the Invention

The present invention relates generally to a messaging service, and more particularly, to a method and apparatus for providing a Direct Push E-mail service.

2. Description of the Related Art

In E-mail services, Direct Push helps users work more efficiently with full wireless synchronization of e-mail by allowing to read an E-mail in real time upon arrival of the E-mail at an E-mail server.

Commonly, to provide a Direct Push E-mail service, an E-mail client periodically sends a command signal periodically to an E-mail server to check whether an E-mail has arrived at the E-mail server. Upon receiving a response message, which indicates the arrival of an E-mail at the E-mail server, the E-mail client receives the E-mail from the E-mail server.

If there is no data exchanged between the E-mail client and the E-mail server for a predetermined time after transmission of the command signal by the Email client to the E-mail server, the E-mail server may send a packet for disconnecting the connection therebetween to the E-mail client. In this case, the E-mail server may undesirably suffer from power consumption as it sends a packet for disconnecting the connection, and the E-mail client may suffer the similar power consumption as it receives the packet for disconnecting the connection from the E-mail server. As a result, this power consumption may cause a reduction in the battery life, especially when the E-mail client is a battery-powered mobile terminal

### SUMMARY OF THE INVENTION

An aspect of an exemplary embodiment of the present invention is to provide a method for providing a Direct Push E-mail service, in which an E-mail client does not need to receive a packet for disconnecting the connection between the E-mail client and an E-mail server, and an E-mail client and an E-mail server therefor.

Another aspect of an exemplary embodiment of the present invention is to provide a method for providing a Direct Push E-mail service, capable of preventing an E-mail client from suffering from power consumption as it receives from an E-mail server a packet for disconnecting the connection between the E-mail client and the E-mail server, and an E-mail client and an E-mail server therefor.

In accordance with one aspect of the present invention, a method for providing a Direct Push E-mail service in an E-mail client includes: establishing a connection to an E-mail server to provide the Direct Push E-mail service; transmitting to the E-mail server a request message including a command signal indicating the E-mail client to periodically send to the E-mail server to check whether an E-mail has arrived at the E-mail server, wherein a connection item in a header of the request message being set as a closed state; and disconnecting the connection upon receiving a response message responsive to the command signal from the E-mail server.

In accordance with another aspect of the present invention, a method for providing a Direct Push E-mail service in an E-mail server includes: establishing a connection to an E-mail client to provide the Direct Push E-mail service; receiving from the E-mail client a request message including a command signal indicating that the E-mail client to periodically send to the E-mail server to check whether an E-mail has arrived at the E-mail server; sending a response message responsive to the command signal to the E-mail client; and determining a connection item in a header of the request message, and disconnecting the connection if the connection item is set as a closed state.

In accordance with further another aspect of the present invention, an E-mail client for providing a Direct Push E-mail service includes: a communication unit for performing communication with an E-mail server; and a controller for establishing a connection to the E-mail server to provide the Direct Push E-mail service, sending to the E-mail server a request message including a command signal indicating the E-mail client to periodically send to the E-mail server to check whether an E-mail has arrived at the E-mail server, a connection item in a header of the request message being set as a closed state, and disconnecting the connection upon receiving a response message responsive to the command signal from the E-mail server.

In accordance with yet another aspect of the present invention, an E-mail server for providing a Direct Push E-mail service includes: a communication unit for performing communication with an E-mail client; and a controller for establishing a connection to the E-mail client to provide the Direct Push E-mail service, receiving from the E-mail client a request message including a command signal indicating the E-mail client to periodically send to the E-mail server to check whether an E-mail has arrived at the E-mail server, sending a response message responsive to the command signal to the E-mail client, determining a connection item in a header of the request message, and disconnecting the connection if the connection item is set as a closed state.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 shows a network configuration for providing a Direct Push E-mail service in a mobile terminal according to an embodiment of the present invention;

FIG. 2 shows a message transmission procedure for a Direct Push E-mail service;

FIG. 3 shows an example of a request message for transmission of the ping command in FIG. 2;

FIG. 4 shows a structure of an E-mail client according to an embodiment of the present invention;

FIG. 5 shows a structure of an E-mail server according to an embodiment of the present invention;

FIG. 6 shows a message transmission procedure for a Direct Push E-mail service according to an embodiment of the present invention;

FIG. 7 shows an example of a request message for transmission of the ping command in FIG. 6;

FIG. 8 shows a processing flow by an E-mail client according to an embodiment of the present invention; and

FIG. 9 shows a processing flow by an E-mail server according to an embodiment of the present invention.

Throughout the drawings, the same drawing reference numerals will be understood to refer to the same elements, features and structures.

### DETAILED DESCRIPTION OF EXEMPLARY EMBODIMENTS

Exemplary embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. For the purposes of simplicity, descriptions of well-known functions and constructions are omitted for clarity and conciseness.

Although a Direct Push E-mail service will be assumed to be made with an E-mail server based on an Exchange ActiveSync (EAS) protocol by a mobile terminal as an E-mail client in embodiments of the present invention by way of example, the teachings of the present invention may be applied to other devices that have the similar technical backgrounds and able to provide E-mail services using the similar EAS protocol-based Direct Push scheme.

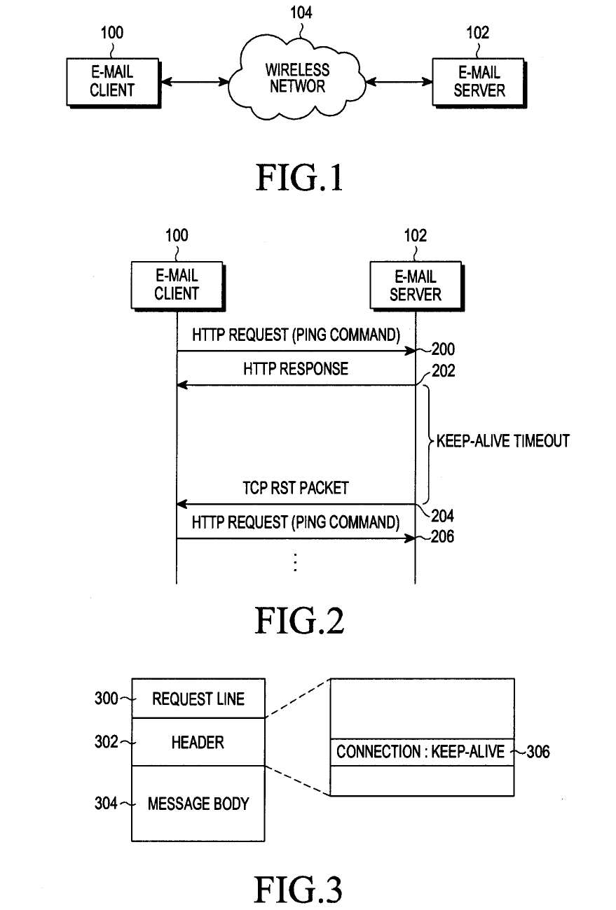

FIG. 1 shows a network configuration for providing a Direct Push E-mail service in a mobile terminal according to an embodiment of the present invention. As shown, an E-mail client 100, or a mobile terminal, provides a Direct Push E-mail service to its user by being connected to an E-mail server 102 over a wireless network 104. The E-mail server 102 pushes an E-mail received with an E-mail account registered by the user of the E-mail client 100, to the E-mail client 100 (or a mobile terminal of the user) in accordance with the Exchange ActiveSync (EAS) protocol.

According to the EAS protocol, in order to support Direct Push, an E-mail client 100 periodically sends a ping command to an E-mail server 102 at a Heart-Bit Interval (HBI) defined in the EAS protocol. The ping command is a command that the E-mail client periodically sends to the E-mail server to check whether an E-mail associated with the E-mail client has arrived at the E-mail server. Note that the term ‘an E-mail having arrived at an E-mail server’ as used herein may refer to an E-mail associated with an E-mail client sending a ping command. Here, the E-mail client 100 sends a ping command to the E-mail server 102 along with a Hyper Text Transfer Protocol (HTTP) request message. All ping commands that one E-mail client 100 sends to the E-mail server 102 are treated as a single socket.

FIG. 2 shows a message transmission procedure for a Direct Push E-mail service. In this example, in an EAS protocol-based Direct Push E-mail service, no E-mail associated with an E-mail client 100 has arrived at an E-mail server 102. Referring to FIG. 2, at the time the E-mail client 100 typically send a ping command to the E-mail server 102, the E-mail client 100 establishes a Transmission Control Protocol (TCP) connection to the E-mail server 102 to provide the Direct Push E-mail service, and sends an HTTP request message including a ping command to the E-mail server 102, in step 200.

The E-mail client 100 sets a connection item “Connection” in a header of the HTTP request message as “Connection: keep-alive” before sending it. In other words, as shown in FIG. 3, in a header 302 of the HTTP request message including a request line 300, the header 302 and a message body 304, the E-mail client 100 sets “Connection” 306 as “Connection: keep-alive” before sending it. For example, in HTTP 1.1, since the basic connection is kept alive between a server and a client, “Connection” is used when the client or the server needs to disconnect the connection.

“Connection: keep-alive” is used by the E-mail server 102 to disconnect a session by sending a TCP RST Packet for disconnecting the TCP connection between the E-mail client 100 and the E-mail server 102, to the E-mail client 100 when keep-alive timeout occurs as there is no data exchanged between the E-mail client 100 and the E-mail server 102 for a predetermined time.

Upon receiving the HTTP request message from the E-mail client 100 in step 200, the E-mail server 102 sends an HTTP response message, which is a response message to the ping command, to the E-mail client 100 in step 202. The HTTP response message is a 200 OK message based on HTTP, and includes a status code indicating whether an E-mail associated with the E-mail client 100 has arrived at the E-mail server 102. If the HTTP response message indicates the existence of an E-mail having arrived at the E-mail server 102, the E-mail client 100 sends a data request to the E-mail server 102 and receives therefrom E-mail data having arrived at the E-mail server 102.

If keep-alive timeout occurs as there is no data exchanged between the E-mail client 100 and the E-mail server 102 for a predetermined time after the E-mail client 100 sent a ping command to the E-mail server 102, then the E-mail server 102 sends a TCP RST Packet to the E-mail client 100 in step 204. Accordingly, the E-mail client 100 and the E-mail server 102 disconnect the TCP connection between the E-mail client 100 and the E-mail server 102.

Thereafter, at the time the E-mail client 100 typically sends again a ping command to the E-mail server 102, the E-mail client 100 establishes a TCP connection to the E-mail server 102 as in step 200, and sends an HTTP request message including a ping command to the E-mail server 102, in step 206. Thereafter, the same steps as steps 202 to 204 are repeated.

As described above, if keep-alive timeout occurs after the E-mail client 100 sent an HTTP request message to the E-mail server 102, the E-mail client 100 suffers from power consumption when it receives a TCP RST Packet sent from the E-mail server 102. In other words, the E-mail client 100 suffers from power consumption as it receives a TCP RST Packet as many times as the number of its sending a ping command to the E-mail server 102. This power consumption may cause a reduction in the battery life, especially when the E-mail client 100 is a mobile terminal

Therefore, it is preferable to prevent an E-mail client from experiencing power consumption as it receives a TCP RST Packet. As explained hereinafter, the inventive scheme allows both client and server to minimize the power consumption thus extending the battery life of a mobile terminal

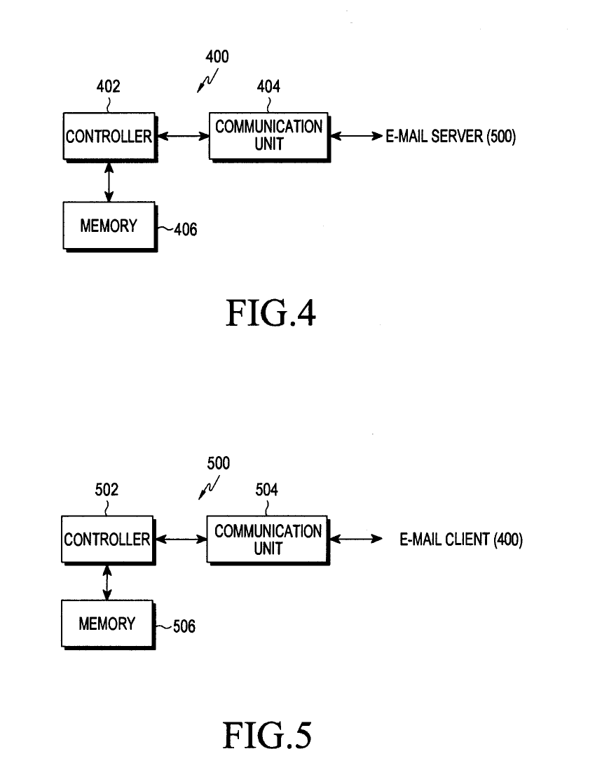

FIG. 4 shows a structure of an E-mail client according to an embodiment of the present invention. As shown, an E-mail client 400 includes a controller 402, a communication unit 404, and a memory 406. The controller 402 performs the below-described control operation proposed by the present invention, as well as the E-mail client's normal function for a Direct Push E-mail service. The communication unit 404 performs communication with an E-mail server 500 shown in FIG. 5, under control of the controller 402. The memory 406 stores a program executed by the controller 402, and stores various data generated during execution of the program by the controller 402. The memory 406 may further include an external memory, and storage such as Hard Disk Drive (HDD).

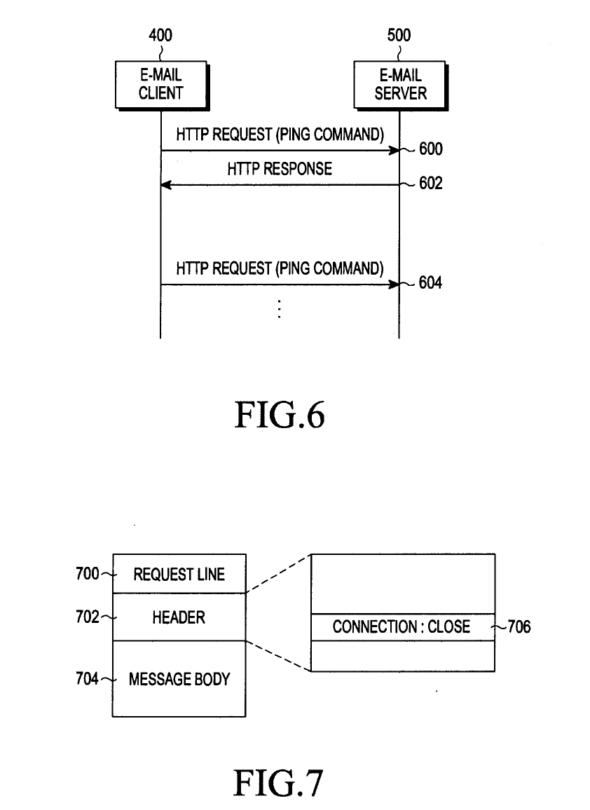

The controller 402 periodically sends a ping command to the E-mail server 500 through the communication unit 404. This will be described in detail below with reference to FIG. 6. FIG. 6 shows a message transmission procedure for a Direct Push E-mail service according to an embodiment of the present invention. In this example, in an EAS protocol-based Direct Push E-mail service, no E-mail associated with an E-mail client 400 has arrived at an E-mail server 500 shown in FIG. 5.

Referring to FIG. 6, at the time the E-mail client 400 sends a ping command, the controller 402 establishes a TCP connection to the E-mail server 500 to provide a Direct Push E-mail service, and sends an HTTP request message including a ping command to the E-mail server 500 via the communication unit 404, in step 600.

The controller 402 sets a connection item “Connection” in a header of the HTTP request message as “Connection: close” before sending it to the E-mail server 500. In other words, the controller 402 sets a connection item “Connection” in a header of the HTTP request message including a ping command, as “Connection: close” instead of above-described “Connection: keep-alive” as in the conventional art, before sending it to the E-mail server 500. That is, as shown in FIG. 7, the controller 402 sets “Connection” 706 in a header 702 of an HTTP request message including a request line 700, the header 702 and a message body 704, as “Connection: close” before sending it to the E-mail server 500. According to HTTP 1.1, “Connection: close” indicates closing of the connection item “Connection”.

Thereafter, in step 602, the controller 402 disconnects the TCP connection between the E-mail client 400 and the E-mail server 500 upon receiving an HTTP response message, which is a response message to the ping command, from the E-mail server 500. If the HTTP response message indicates the existence of an E-mail having arrived at the E-mail server 500, the controller 402 receives an E-mail having arrived at the E-mail server 500 from the E-mail server 500 before disconnecting the TCP connection.

Thereafter, at the time the E-mail client 400 sends a ping command to the E-mail server 500 again, the controller 402 establishes a TCP connection to the E-mail server 500 as in step 600, and sends an HTTP request message including a ping command to the E-mail server 500, in step 604. Thereafter, the same steps as steps 600 to 602 are repeated.

FIG. 5 shows a structure of an E-mail server according to an embodiment of the present invention. As shown, the E-mail server 500 includes a controller 502, a communication unit 504, and a memory 506.

Referring to FIG. 5, the controller 502 performs the below-described control operation proposed by the present invention, as well as the E-mail server's normal function for a Direct Push E-mail service. The communication unit 504 performs communication with the E-mail client 400 under control of the controller 502. The memory 506 stores a program executed by the controller 502, and stores various data generated during execution of the program by the controller 502. The memory 506 may further include an external memory, and storage such as HDD.

Referring back to FIG. 6, upon request from the E-mail client 400 in step 600, the controller 502 establishes a TCP connection to the E-mail client 400 to provide a Direct Push E-mail service, and receives an HTTP request message including a ping command from the E-mail client 400 through the communication unit 504. In step 602, the controller 502 sends an HTTP response message, which is a response message to the ping command, to the E-mail client 400 via the communication unit 504.

The controller 502 determines a connection item “Connection” in a header of the HTTP request message, and if the connection item “Connection” is set as “Connection: close”, the controller 502 sends an HTTP response message to the E-mail client 400 and then disconnects the TCP connection between the E-mail client 400 and the E-mail server 500. If there is an E-mail having arrived at the E-mail server 500, the controller 502 sends the E-mail having arrived at the E-mail server 500 and stored in the memory 506, to the E-mail client 400 via the communication unit 504 before disconnecting the TCP connection.

Thereafter, at the time the E-mail client 400 sends a ping command to the E-mail server 500 again, the controller 502 establishes a TCP connection to the E-mail client 400 as in step 600, and receives an HTTP request message including a ping command from the E-mail client 400 via the communication unit 504, in step 604. Thereafter, the same steps as steps 600 to 602 are repeated.

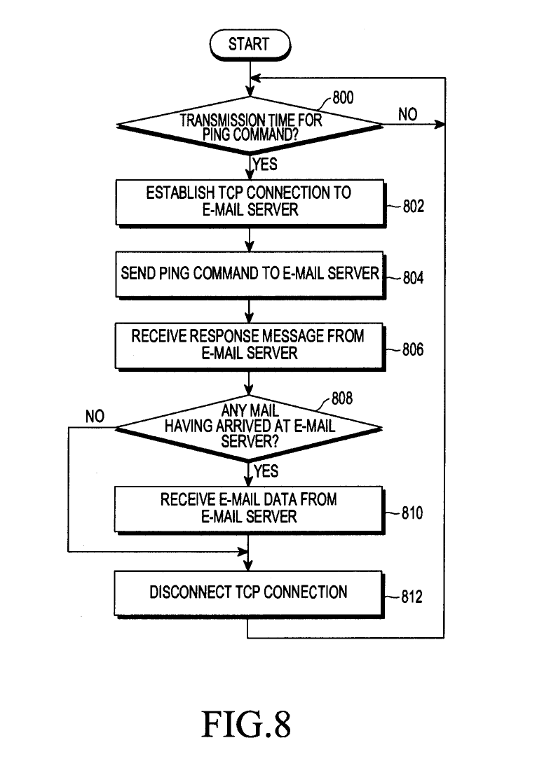

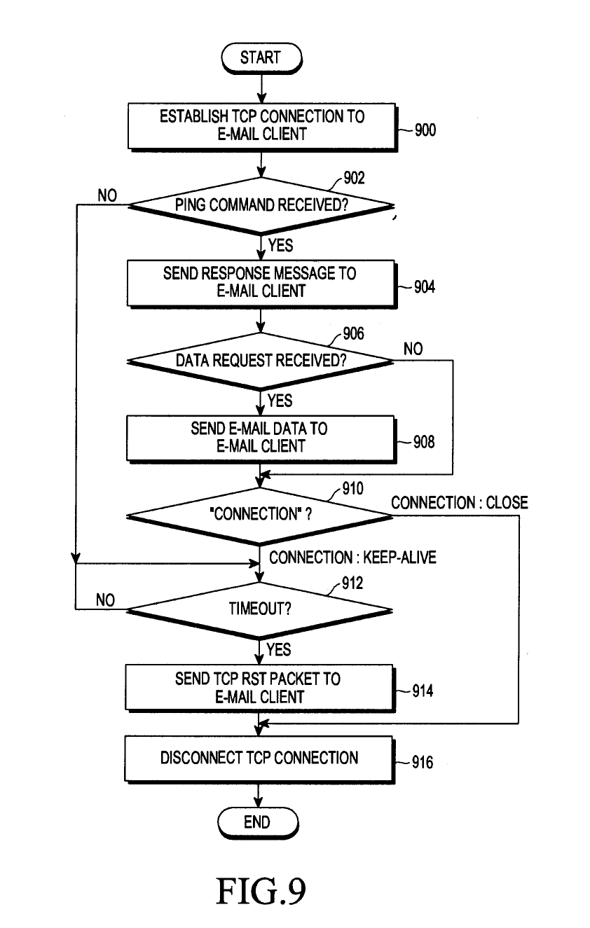

Hereinafter, operations of the E-mail client 400 and the E-mail server 500 will be described in detail with reference to FIGS. 8 and 9. FIG. 8 shows a processing flow by an E-mail client 400 according to an embodiment of the present invention, and FIG. 9 shows a processing flow by an E-mail server 500 according to an embodiment of the present invention.

At the time the E-mail client 400 sends a ping command in step 800, the controller 402 of the E-mail client 400 establishes a TCP connection to the E-mail server 500 to provide a Direct Push E-mail service in step 802, and sends an HTTP request message including a ping command to the E-mail server 500 in step 804. The controller 402, as described above, sets a connection item “Connection” in a header of the HTTP request message as “Connection: close” before sending it to the E-mail server 500.

In step 900, upon request from the E-mail client 400, the controller 502 of the E-mail server 500 establishes a TCP connection to the E-mail client 400 to provide a Direct Push E-mail service. Upon receiving an HTTP request message including a ping command from the E-mail client 400 in step 902, the controller 502 sends an HTTP response message to the E-mail client 400 in step 904.

The controller 402 of the E-mail client 400 receives the HTTP response message sent from the E-mail server 500 in step 806, and determines a status code in the HTTP response message, which indicates whether an E-mail associated with the E-mail client 400 has arrived at the E-mail server 500, in step 808. If the HTTP response message indicates the absence of an E-mail having arrived at the E-mail server 500, the controller 402 disconnects the TCP connection between the E-mail client 400 and the E-mail server 500 in step 812. In contrast, if the HTTP response message indicates the existence of an E-mail having arrived at the E-mail server 500, the controller 402 requests and receives E-mail data having arrived at the E-mail server 500 from the E-mail server 500 in step 810, before performing step 812. In other words, the controller 402 receives an E-mail having arrived at the E-mail server 500 from the E-mail server 500 before disconnecting the TCP connection.

After sending an HTTP response message to the E-mail client 400 in step 904, upon receiving a data request from the E-mail client 400 in step 906, the controller 502 of the E-mail server 500 sends E-mail data having arrived at the E-mail server 500 to the E-mail client 400 in step 908. Upon receiving no data request from the E-mail client 400 in step 906 or after performing step 908, the controller 502 proceeds to step 910.

In step 910, the controller 502 determines a connection item “Connection” in a header of the HTTP request message. If the connection item “Connection” is set as “Connection: close”, the controller 502 disconnects the TCP connection between the E-mail client 400 and the E-mail server 500 in step 916. In contrast, if the connection item “Connection” is set as “Connection: keep-alive”, the controller 502 determines in step 912 whether keep-alive timeout occurs. If keep-alive timeout occurs, the controller 502 sends a TCP RST Packet to the E-mail client 400 in step 914, and then disconnects the TCP connection between the E-mail client 400 and the E-mail server 500 in step 916.

Thereafter, at the time the E-mail client 400 sends a ping command to the E-mail server 500 again, the controller 402 repeats steps 802 to 812 and according thereto, the controller 502 of the E-mail server 500 also repeats steps 900 to 916.

As described above, when periodically sending a ping command to the E-mail server 500, the E-mail client 400 sets a connection item “Connection” in a header of the HTTP request message as “Connection: close”. Accordingly, after sending an HTTP response message to the ping command to the E-mail client 400, the E-mail server 500 disconnects the TCP connection between the E-mail client 400 and the E-mail server 500 without the need to send a TCP RST Packet to the E-mail client 400. After receiving the HTTP response message to the ping command from the E-mail server 500, even the E-mail client 400 may not receive the TCP RST Packet.

Therefore, as described above, after the E-mail client 400 sends an HTTP request message to the E-mail server 500, the E-mail server 500 does not need to send a TCP RST Packet to the E-mail client 400 and the E-mail client 400 does not need to receive the TCP RST Packet from the E-mail server 500, thereby preventing the power consumption occurring when the E-mail server 500 sends a TCP RST Packet to the E-mail client 400, and also preventing the power consumption occurring when the E-mail client 400 receives a TCP RST Packet from the E-mail server 500.

As a result, the battery life may be improved, especially when the E-mail client 400 is a battery-powered mobile terminal.

While the invention has been described in detail with reference to certain exemplary embodiments thereof, various changes may be made without departing from the spirit and scope of the invention. For example, it is assumed in an embodiment of the present invention that the E-mail server 500 determines a connection item “Connection” in a header of an HTTP request message in step 910 of FIG. 9, and if the connection item “Connection” is set as “Connection: keep-alive”, the E-mail server 500 processes data depending on whether keep-alive timeout occurs in step 912. However, in actual implementation of the embodiment of the present invention, the keep-alive timeout-related processing may be omitted because the E-mail client 400 sets a connection item “Connection” in a header of an HTTP request message as “Connection: close” before sending it to the E-mail server 500.

In addition, exemplary embodiments of the present invention may be applied to other devices with a slight modification by those of ordinary skill in the art without departing from the scope and spirit of the invention. In other words, in a Direct Push E-mail service, when there is no data exchanged between an E-mail client and an E-mail server for a predetermined time after the E-mail client sent to the E-mail server a command having the same function as that of a ping command, embodiments of the present invention may be applied to desktop computers as well as various mobile terminals such as notebook computers, tablet computers, mobile phones, and smart phones, in the case where the E-mail server sends a packet for disconnecting the connection between the E-mail client and the E-mail server, to the E-mail client.

Moreover, exemplary embodiments of the present invention may be realized in the form of hardware, software, or a combination thereof. The arbitrary software may be stored, for example, in a volatile or non-volatile storage device such as Read Only Memory (ROM) and Radom Access Memory (RAM) no matter whether it is erasable or re-writable, or in a storage medium which is optically or magnetically recordable and is readable by machine, such as Compact Disk (CD), Digital Versatile Disk (DVD), magnetic disk, and magnetic tape. For example, it can be understood that a memory mountable in a mobile terminal supporting a Direct Push E-mail service may be a mere example of the storage media, which is suitable to store a program(s) including instructions implementing embodiments of the present invention and is readable by machine. Therefore, the present invention includes a program including codes for implementing an apparatus and method defined in any claims of this specification, and a storage medium which stores this program and is readable by machine (e.g., computer). In addition, this program may be electronically transferred by means of any medium such as communication signals which are transmitted by wired/wireless connection, and the present invention may properly include equivalents thereto.

The above-described Direct Push E-mail service method proposed by the present invention may be produced in a program and stored in a storage medium. A mobile terminal supporting a Direct Push E-mail service may download a program (e.g., an application) for controlling the Direct Push E-mail service according to an embodiment of the present invention, from a remote program server, or install the program therein, and execute the program, so the mobile terminal may be used for the Direct Push E-mail service. In other words, if installed in a mobile terminal, the program for a Direct Push E-mail service may be executed in the mobile terminal, providing the Direct Push E-mail service. Upon receiving a transmission request for the program from the mobile terminal, the program server transmits the program to the mobile terminal in response to the transmission request. For the mobile terminal that has requested transmission of the program, the program server may determine whether it (i.e., the mobile terminal) has subscribed to the Direct Push E-mail service, authenticate its user, and check its payment information. The program server may include a storage medium that stores the program. The storage medium may be mounted either inside or outside of the program server.

Therefore, the scope of the present invention should not be limited to the above-described embodiments, and should be defined by the appended claims and their equivalents.

What is claimed is:

1. A method for providing a Direct Push E-mail service in an E-mail client, comprising:
establishing a connection to an E-mail server;
transmitting to the E-mail server a request message including a command to check whether an E-mail has arrived at the E-mail server, wherein a connection item in a header of the request message is set as a closed state; and
disconnecting the connection upon receiving a response message responsive to the command from the E-mail server.

2. The method of claim 1, wherein the disconnecting further comprises receiving the E-mail arrived at the E-mail server from the E-mail server before disconnecting the connection when the response message indicates an existence of the E-mail arrived at the E-mail server.

3. The method of claim 2, wherein the E-mail client is a mobile terminal

4. The method of claim 3, wherein the Direct Push E-mail service is made based on an Exchange ActiveSync (EAS) protocol.

5. The method of claim 4, wherein the connection is a Transmission Control Protocol (TCP) connection, the command is a ping command, and the request message is a Hyper Text Transfer Protocol (HTTP) request message; and
wherein the closed state of the connection item is set by setting a connection item “Connection” in a header of the HTTP request message as “Connection: close”.

6. A method for providing a Direct Push E-mail service in an E-mail server, comprising:
establishing a connection to an E-mail client;
receiving from the E-mail client a request message including a command to check whether an E-mail has arrived at the E-mail server;
transmitting, to the Email client, a response message responsive to the command; and
determining a connection item in a header of the request message and disconnecting the connection if the connection item is set as a closed state.

7. The method of claim 6, wherein the disconnecting further comprises sending the E-mail arrived at the E-mail server to the E-Mail client before disconnecting the connection when the E-mail arrived at the E-Mail server exists.

8. The method of claim 7, wherein the E-mail client is a mobile terminal.

9. The method of claim 8, wherein the Direct Push E-mail service is made based on an Exchange ActiveSync (EAS) protocol.

10. The method of claim 9, wherein the connection is a Transmission Control Protocol (TCP) connection, the command is a ping command, and the request message is a Hyper Text Transfer Protocol (HTTP) request message; and
wherein the closed state of the connection item is set by setting a connection item “Connection” in a header of the HTTP request message as “Connection: close”.

11. An E-mail client for providing a Direct Push E-mail service, comprising:
a communication unit for performing communication with an E-mail server; and
a controller for establishing a connection to the E-mail server to provide the Direct Push E-mail service, transmitting to the E-mail server a request message including a command to check whether an E-mail has arrived at the E-mail server, wherein a connection item in a header of the request message being set as a closed state, and disconnecting the connection upon receiving a response message responsive to the command from the E-mail server.

12. The E-mail client of claim 11, wherein the controller receives the E-mail arrived at the E-mail server from the E-mail server before disconnecting the connection when the response message indicates existence of the E-mail arrived at the E-mail server.

13. The E-mail client of claim 12, wherein the E-mail client is a mobile terminal.

14. The E-mail client of claim 13, wherein the Direct Push E-mail service is made based on an Exchange ActiveSync (EAS) protocol.

15. The E-mail client of claim 14, wherein the connection is a Transmission Control Protocol (TCP) connection, the command is a ping command, and the request message is a Hyper Text Transfer Protocol (HTTP) request message; and
wherein the controller sets the connection item as a closed state by setting a connection item “Connection” in a header of the HTTP request message as “Connection: close”.

16. An E-mail server for providing a Direct Push E-mail service, comprising:
a communication unit for performing communication with an E-mail client; and
a controller for establishing a connection to the E-mail client to provide the Direct Push E-mail service, receiving from the E-mail client a request message including a command to check whether an E-mail has arrived at the E-mail server, sending a response message responsive to the command to the E-mail client, determining a connection item in a header of the request message, and disconnecting the connection if the connection item is set as a closed state.

17. The E-mail server of claim 16, wherein the controller sends the E-mail arrived at the E-mail server to the E-Mail client before disconnecting the connection when the E-mail arrived at the E-Mail server exists.

18. The E-mail server of claim 17, wherein the E-mail client is a mobile terminal.

19. The E-mail server of claim 18, wherein the Direct Push E-mail service is made based on an Exchange ActiveSync (EAS) protocol.

20. The E-mail server of claim 19, wherein the connection is a Transmission Control Protocol (TCP) connection, the command is a ping command, and the request message is a Hyper Text Transfer Protocol (HTTP) request message; and
wherein the closed state of the connection item is set by setting a connection item “Connection” in a header of the HTTP request message as “Connection: close”.
